(19) United States
(12) Patent Application Publication
(10) Pub. No.: US 2002/0054052 A1
(43) Pub. Date: May 9, 2002

(54) FRAME-BASED WEB BROWSER

(76) Inventors: NANDINI SHARMA, SAN JOSE, CA (US); NEELAKANTAN SUNDARESAN, SAN JOSE, CA (US)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 09/225,955

(22) Filed: Jan. 6, 1999

(51) Int. Cl. G06F 13/00

(52) U.S. Cl. 345/700

(57) ABSTRACT

A frame-based web browser displays multiple frames in single window in a user-controlled manner. Each of the frames displays a different page from the same web site or from different web sites. The frame-based web browser provides a number of different functions, including functions to create a new frame in a window, delete a frame from a window, open a uniform resource locator (URL) in a frame, and for navigating between frames.

### BACKGROUND OF THE INVENTION

1. Field of the Invention

This invention relates in general to web browsers, and more particularly, to a frame-based web browser.

2. Description of Related Art

Often, related information needs to be viewed and browsed together when navigating the World Wide Web of the Internet. For example, the Uniform Resource Locater (URL) http://www.telegraph.com identifies a web site maintained by the London Telegraph, which has daily crosswords. On this web site, the solutions are posted the next day for any day's crossword, but the solutions page does not contain the clues that were given on the previous day. Therefore, a user who would like to check the solutions of any crossword must display and switch between two independent browser windows, i.e., one containing the previous day's crossword and the other containing the next day's solutions page. The content provider could have put both sets of information on the same page; however, this may be difficult considering the two pages are created at different points of time.

Another scenario that may arise occurs when a user wants to view two different sets of information from two different web sites simultaneously. As above, the user has to invoke and display two independent browser windows and keep switching between the two windows.

HyperText Markup Language (HTML) does allow content providers to use frames to place multiple related sets of information on the same page, but in different frames; however, if the content provider does not use framing, it remains difficult for the user to identify the two pages as being related and display both pages simultaneously using two browser windows.

It can be seen, then, that there is a need in the art for a web browser that supports multiple frames in the same window to display multiple pages on the Internet.

### SUMMARY OF THE INVENTION

To minimize the limitations in the prior art described above, and to minimize other limitations that will become apparent upon reading and understanding the present specification, the present invention discloses a method, apparatus, and article of manufacture for providing a frame-based web browser that displays multiple frames in single window in a user-controlled manner. Each of the frames displays a different page from the same web site or from different web sites. The frame-based web browser provides a number of different functions, including functions to create a new frame in a window, delete a frame from a window, open a uniform resource locator (URL) in a frame, and for navigating between frames.

An object of the present invention is to enhance the delivery of Web content to the user. Another object is to provide mechanisms for more efficiently displaying Web content to the user.

A feature of the present invention is that it can be realized on many current commercial web browser products with relatively low cost, because it can be implemented with well-structured extensions to existing software. Another feature of the present invention is that none of the other existing software systems have to be changed to implement the present invention.

### BRIEF DESCRIPTION OF THE DRAWINGS

Referring now to the drawings in which like reference numbers represent corresponding parts throughout:

FIG. 1 is a block diagram of an exemplary hardware environment of the preferred embodiment of the present invention, and more particularly, illustrates a typical distributed computer system;

FIG. 2 illustrates a multiple frame window displayed by a web browser according to the preferred embodiment of the present invention; and

FIG. 3 is a flowchart illustrating the logic performed by a web browser according to the preferred embodiment of the present invention.

### DETAILED DESCRIPTION OF THE PREFERRED EMBODIMENT

In the description of the preferred embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

Overview

The present invention, known as a Frame-Based Web Browser, helps alleviate the problems of displaying multiple pages retrieved from the Internet through the use of multiple frames within a single window. The pages may comprise text data, graphics data, audio data, audiovisual data, or other data as desired.

Hardware Environment

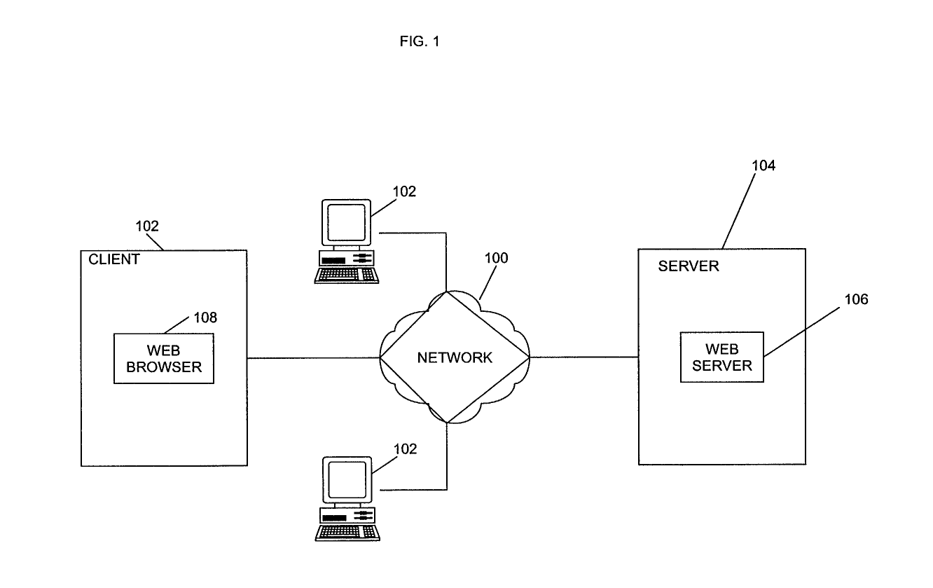

FIG. 1 is a block diagram of an exemplary hardware environment of the preferred embodiment of the present invention, and more particularly, illustrates a typical distributed computer system, wherein a network 100 connects client computers 102 to server computers 104. The network 100 preferably comprises the Internet, although it could also comprise intranets, extranets, LANs, WANs, SNA networks, etc. A typical combination of resources may include client computers 102 that are personal computers or workstations, and server computers 104 that are personal computers, workstations, minicomputers, and/or mainframes.

Each of the computers generally include, inter alia, a processor, random access memory (RAM), data storage devices, data communications devices, monitors, input devices, etc. Of course, those skilled in the art will recognize that any combination of the above components, or any number of different components, peripherals, and other devices, may be used in the present invention.

In the present invention, the server computer 104 executes a web server 106, and the client computer 102 executes a web browser 108. The web server 106 is typically a computer program such as IBM's HTTP daemon or other World Wide Web (WWW) daemon, and the web browser 108 is typically a computer program such as IBM's Web Explorer™, Netscape's Navigator™, Microsoft's Internet Explorer™, etc.

Generally, the web browser 108 (and the web server 106) comprises instructions and/or data which, when read, executed, and/or interpreted by the client computer 102, causes the client computer 102 to perform the steps necessary to implement and/or use the present invention. The web browser 108 is usually embodied in and/or readable from a device, carrier, or media, such as a memory, data storage device, and/or a remote device coupled to the computer via a data communications device.

Thus, the present invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass instructions and/or data accessible from any device, carrier, or media. Of course, those skilled in the art will recognize many modifications may be made to this configuration without departing from the scope of the present invention.

Those skilled in the art will recognize that the exemplary environment illustrated in FIG. 1 is not intended to limit the present invention. Indeed, those skilled in the art will recognize that other alternative hardware environments may be used without departing from the scope of the present invention.

Frame-based Web Browser

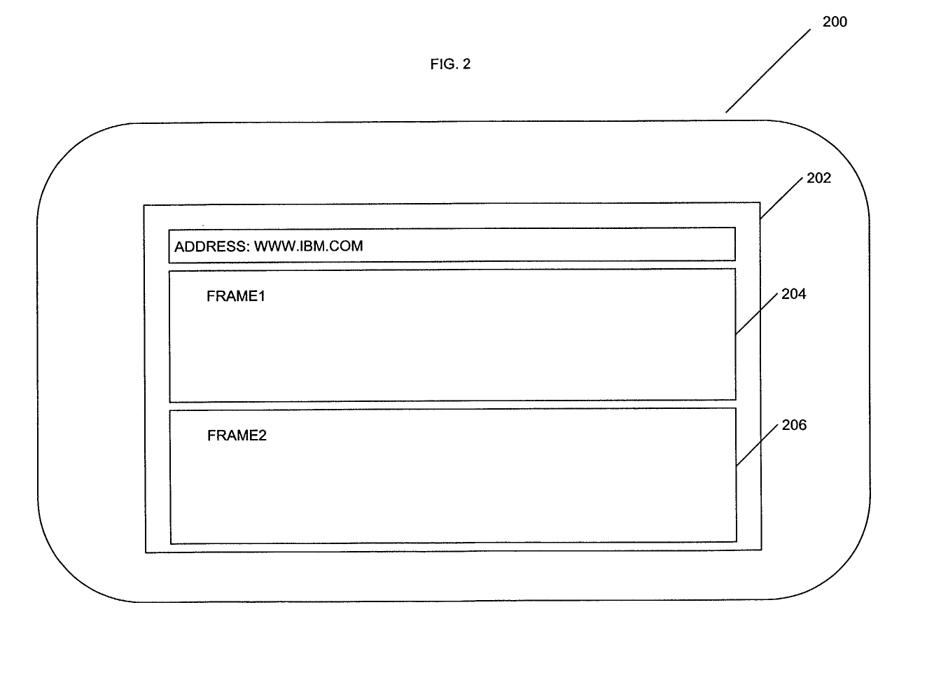

FIG. 2 illustrates a monitor 200 of a client computer 102 displaying an exemplary window 202 having two frames 204, 206 therein according to the preferred embodiment of the present invention. Generally, this window 202 is displayed and controlled via the web browser 108 or other utility. The window 202 includes menus and the like for enabling and disabling the use of the multiple frames 204, 206.

Operation of the Web Browser

The preferred embodiment of the present invention is a frame-based web browser 108 that allows a user to display multiple web pages from multiple web sites or same web site in a single, common window because it allows multiple frames to be displayed in a single window.

Prior art browsers, such as Netscape Navigator and Internet Explorer, only provide controls for the user to create new window instances in a browser. Moreover, only the web page designer can designate multiple frames within a window, and these frames are considered as part of the same web page. However, there is no mechanism in these prior art browsers to create a new frame within the same window in a user-controlled way.

In contrast, the preferred embodiment of the present invention provides an extension to the web browser 108 that allows multiple pages to be displayed in multiple frames in a single window. The multiple frames can be independently scrolled, but since they belong to the same window, they can be displayed or closed together or separately.

During operation, the browser identifies a “current” frame. This is the frame which has the browser's “focus” at a particular point in time. The page in the current frame is considered to be the current page.

According to the preferred embodiment of the present invention, the improved web browser 108 provides the following functions:

1. Create a new frame: This function converts the current page into a frame and adds another frame within the same window. The new frame can be initialized with the contents of a page or can be empty.

2. Delete a frame: This function deletes a particular frame and resizes the other frame(s), if any, to occupy the window space freed by the deleted frame.

3. Open URL in frame: This function opens a URL within a particular frame.

4. Navigate between frames: This function allows navigation between frames, e.g., selecting a next frame, a previous frame, a particular frame, etc.

These various functions are described in more detail below.

Create a New Frame

This function causes the browser to create a new frame in the current window displayed by the web browser 108. Generally, this function is invoked to connect to a URL for display in the frame.

It is envisioned that this function could be invoked in a number of different ways.

For example, the user may select a hyperlink on a displayed page, right-click the mouse to display a menu, and select a function “Open link in new frame” to invoke the function and display the desired page within the new frame.

In another example, the user may select a menu function “Open URL in new frame” from a window menu, wherein a dialog box is displayed, the user enters a desired URL into the dialog box, and the browser retrieves and displays the desired page in the new frame.

Regardless of how the function is invoked, the browser reformats the window, so as to add an additional frame and then displays the newly retrieved page in the newly added frame. Thereafter, the browser moves its focus to the newly created frame.

Since more than one page can be displayed in a window having multiple frames, scroll bars may be enabled in all those frames where the size of the page exceeds the size of the frame. Alternatively, the font size may be altered or other formatting steps taken to enhance the viewability of the information displayed within the frames. It is envisioned that any function that can be performed in a window can also be performed within a frame.

Delete a Frame

This function causes the browser to delete a frame from the current window displayed by the web browser 108. Generally, this function is invoked to delete the frame that is currently the focus of the browser.

It is envisioned that this function could be invoked in a number of different ways.

For example, the user may select an “X” box in the upper right hand corner of the frame. In another example, the user may press the ALT+F4 keys together. In yet another example, the user may select a “Delete” function from a window menu.

Regardless of how the function is invoked, the browser reformats the window, so as to reuse the space previously occupied by the deleted frame and provide optimal viewing of the remaining frames. Thereafter, the browser moves its focus to another frame in the window.

Usually, the Web browser 108 moves its focus to a frame that is visually adjacent to the frame that was deleted. On the other hand, the web browser 108 may change its focus based on the order that the frames were created, so that the focus is on a previous or later frame. Generally, if only one frame is left after a frame is deleted, then the remaining frame is the root window of the browser.

Open URL in Frame

This function causes the browser to open a page indicated by the URL in the current frame. The contents of the frame can be replaced at any time by this function.

Navigate Between Frames

This function typically comprises a number of different sub-functions, all of which change the focus of the browser from one frame to another. For example, a frame is typically brought into focus by moving the cursor into the new frame. In another example, a sequence of keystrokes (e.g., a sequence of TAB keystrokes) may designate the focus on a particular frame or cause the focus to traverse from one frame to another according to a particular order (e.g., the frames' order of creation).

Logic of the Web Browser

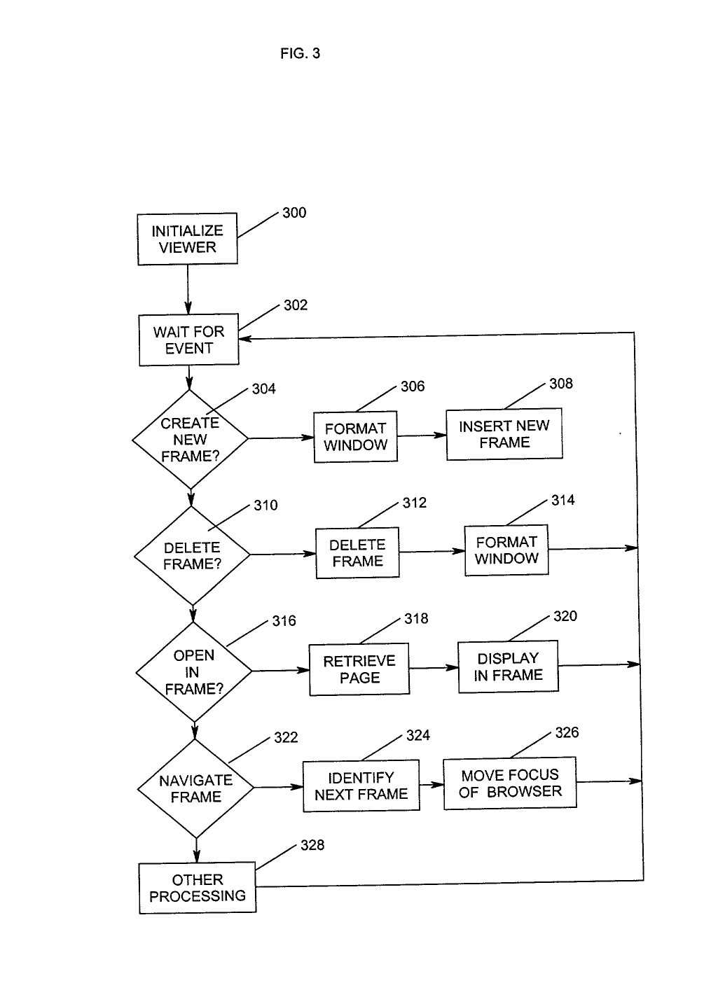

FIG. 3 is a flowchart illustrating the logic performed by web browser 108 according to the preferred embodiment of the present invention.

Block 300 represents the web browser 108 being initialized.

Block 302 represents the web browser 108 waiting for the next event to occur, such as the receipt of input from the user.

Block 304 is a decision block that represents the web browser 108 determining whether the event was the invocation of the “create a new frame” function. If so, control transfers to Blocks 306 and 308; otherwise, control transfers to Block 310.

Blocks 306 and 308 represent the web browser 108 performing the functions associated with the “create a new frame” function, such as formatting the window to accept the new frame and then inserting the new frame in the window. These steps may or may not include retrieving a page for display in the new frame. Thereafter, control is transferred to Block 302.

Block 310 is a decision block that represents the web browser 108 determining whether the event was the invocation of the “delete frame” function. If so, control transfers to Blocks 312 and 314; otherwise, control transfers to Block 316.

Blocks 312 and 314 represent the web browser 108 performing the functions associated with the “delete frame” function, such as deleting the specified frame and then re-formatting the window to occupy the space used by the deleted frame. Thereafter, control is transferred to Block 302.

Block 316 is a decision block that represents the web browser 108 determining whether the event was the invocation of the “open URL in frame” function. If so, control transfers to Blocks 318 and 320; otherwise, control transfers to Block 322.

Blocks 318 and 320 represent the web browser 108 performing the functions associated with the “open URL in frame” function, such as retrieving the desired page and then displaying the retrieved page in the specified frame. Thereafter, control is transferred to Block 302.

Block 322 is a decision block that represents the web browser 108 determining whether the event was the invocation of the “navigate frame” function. If so, control transfers to Blocks 324 and 326; otherwise, control transfers to Block 328.

Blocks 324 and 326 represent the web browser 108 performing the functions associated with the “navigate frame” function, such as identifying the next frame and then moving the focus of the web browser 108 to the identified frame. Thereafter, control is transferred to Block 302.

Block 328 represents the web browser 108 performing other processing. Thereafter, control is transferred to Block 302.

### CONCLUSION

This concludes the description of the preferred embodiment of the invention. The following describes some alternative embodiments for accomplishing the present invention.

For example, those skilled in the art will recognize that any type of computer configuration and/or network configuration could benefit from the present invention. Those skilled in the art will also recognize that many types of frames and frame controls could be used, in addition to those enumerated herein. In addition, those skilled in the art will also recognize that the function described herein could be invoked in many different ways.

In summary, the present invention discloses a method, apparatus, and article of manufacture for providing a frame-based web browser that displays multiple frames in single window in a user-controlled manner. Each of the frames displays a different page from the same web site or from different web sites. The frame-based web browser provides a number of different functions, including functions to create a new frame in a window, delete a frame from a window, open a uniform resource locator (URL) in a frame, and for navigating between frames.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method of browsing a network, comprising:
(a) displaying a plurality of frames in a window displayed by a browser executed by a computer, the frames being displayed in response to a user command received by the computer;
(b) retrieving a plurality of pages from a server on the network; and
(c) displaying each of the pages in a different one of the frames.

2. The method of claim 1, further comprising identifying a current one of the frames as a focus of the browser.

3. The method of claim 1, further comprising creating a new frame in the window.

4. The method of claim 3, further comprising initializing the new frame with a page's contents.

5. The method of claim 3, further comprising initializing the new frame as empty.

6. The method of claim 1, further comprising deleting a particular one of the frames and resizing others of the frames to occupy the window's space freed by the deleted frame.

7. The method of claim 1, further comprising retrieving a page from the network as designated by an identifier and displaying the retrieved page in one of the frames.

8. The method of claim 1, further comprising navigating between the frames.

9. An apparatus for browsing a network, comprising:
(a) a client computer connected to the network; and
(b) a browser, executed by the client computer, for displaying a plurality of frames in a window displayed by a browser executed by a computer, the frames being displayed in response to a user command received by the computer; for retrieving a plurality of pages from a server on the network; and for displaying each of the pages in a different one of the frames.

10. The apparatus of claim 9, wherein the browser further comprises means for identifying a current one of the frames as a focus of the browser.

11. The apparatus of claim 9, wherein the browser further comprises means for creating a new frame in the window.

12. The apparatus of claim 11, wherein the browser further comprises means for initializing the new frame with a page's contents.

13. The apparatus of claim 11, wherein the browser further comprises means for initializing the new frame as empty.

14. The apparatus of claim 9, wherein the browser further comprises means for deleting a particular one of the frames and for resizing others of the frames to occupy the window's space freed by the deleted frame.

15. The apparatus of claim 9, wherein the browser further comprises means for retrieving a page from the network as designated by an identifier and for displaying the retrieved page in one of the frames.

16. The apparatus of claim 9, wherein the browser further comprises means for navigating between the frames.

17. An article of manufacture embodying logic for performing method steps for browsing on a network, the method comprising the steps of:
(a) displaying a plurality of frames in a window displayed by a browser executed by a computer, the frames being displayed in response to a user command received by the computer;
(b) retrieving a plurality of pages from a server on the network; and
(c) displaying each of the pages in a different one of the frames.

18. The method of claim 17, further comprising identifying a current one of the frames as a focus of the browser.

19. The method of claim 17, further comprising creating a new frame in the window.

20. The method of claim 19, further comprising initializing the new frame with a page's contents.

21. The method of claim 19, further comprising initializing the new frame as empty.

22. The method of claim 17, further comprising deleting a particular one of the frames and resizing others of the frames to occupy the window's space freed by the deleted frame.

23. The method of claim 17, further comprising retrieving a page from the network as designated by an identifier and displaying the retrieved page in one of the frames.

24. The method of claim 17, further comprising navigating between the frames.
